(19) United States
(12) Patent Application Publication
(10) Pub. No.: US 2002/0155201 A1
(43) Pub. Date: Oct. 24, 2002

(54) Emulsion for processed meat and processed meat using the emulsion

(75) Inventors: Kunio Okada, Noda-Shi (JP); Katsuichi Tokumoto, Ebetsu-Shi (JP)

Correspondence Address: YOUNG & THOMPSON, 745 SOUTH 23RD STREET 2ND FLOOR, ARLINGTON, VA, 22202

(73) Assignee: HOKUBEE CO., LTD., ISHIKARI-SHI (JP)

(21) Appl. No.: 10/036,421

(22) Filed: Jan. 7, 2002

(30) Foreign Application Priority Data
Jan. 5, 2001 (JP) 839/2001

(51) Int. Cl. A23L 1/31

(52) U.S. Cl. 426/281

(57) ABSTRACT

An emulsion for processed meat which comprises (A) oil and fat of animal and plant, (B) at least one substance selected from (a) at least one compound selected from sucrose fatty acid esters, monoglycerides, polyglycerides and lecithins and (b) at least one substance selected from proteins of animals and plants, hydrolysis protein and enzyme decomposed protein, and (C) at least one compound selected from basic amino acids and salts thereof and a processed meat comprising the above emulsion which is uniformly distributed in the meat.

The emulsion exhibits an excellent emulsifying property, stability and flavor. The processed meat exhibits excellent color, texture and flavor.

### BACKGROUND OF THE INVENTION

1. Field of the Invention

The present invention relates to an emulsion for processed meat and a processed meat using the emulsion. More particularly, the present invention relates to an emulsion for processed meat which exhibits an excellent emulsifying property, stability in a wide range of temperature and flavor and is advantageously used for producing meat exhibiting excellent color, texture (feel of fiber and feel to teeth) and flavor and a processed meat which is obtained by using the above emulsion and has the above advantageous properties.

2. Description of Related Art

Heretofore, in Japan, “marbled beef” containing white fat dispersed in red meat of beef to give marble-like appearance is eaten as a high quality meat. However, the marbled beef has a drawback in that the relative amount of production of the marbled beef in the entire beef is very small.

To overcome the above drawback, it is conducted that an emulsion containing fat which is solid at the ordinary temperature is injected into red meat containing fat in a small amount and available in a great amount using an injector equipped with needles. The injected emulsion is dispersed uniformly and fat in the emulsion is separated within the meat to produce the marbled beef (Japanese Patent Application Publication Showa 59(1984)-23777).

However, the marbled beef produced in accordance with the above process has drawbacks in that (1) it is difficult that the marble-like pattern is formed uniformly throughout the meat and the appearance tends to become unnatural; (2) discoloration and change in color tend to take place with time and it is difficult that the natural color of meat is maintained; (3) natural feel to teeth, feel of fiber and flavor exhibited by beef cannot be sufficiently exhibited; (4) the aftertaste is not satisfactory; and (5) the type of beef used as the raw material is limited and control of juicy feel is difficult. Therefore, the above marbled beef is not always satisfactory.

The above drawbacks are caused by the emulsion containing fat which is injected into red meat of beef as described in the following.

In the process for producing the marbled beef described in the above reference (Japanese Patent Application Publication Showa 59(1984)-23777), in accordance with the descriptions in the examples, tallow or a mixture of tallow and salad oil and water containing sodium caseinate, hydrolysis protein and enzyme decomposed proteins, natural gum, phosphates, hydrolysis starch and enzyme decomposed starch, and water-soluble gelatin are emulsified and the obtained emulsion is used.

However, the above emulsion has the following drawbacks. Viscosity varies greatly depending on the temperature and fluidity of the emulsion decreases at lower temperatures during the production of marbled beef. As the result, the marble-like pattern is not exhibited uniformly throughout the meat and the appearance tends to become unnatural. Discoloration and change in color of meat tend to take place with time due to the effect of the phosphate in the emulsion. Since the addition of the phosphate further causes dissolution of the membrane of cells constituting muscle fibers, the muscle fibers are softened and water is held due to an enhanced property to absorb water. However, at the same time, the feel on eating loses the feel of fiber and changes into characteristic elasticity and elastic feel of a boiled fish paste and natural feel to teeth and feel of fiber of meat becomes insufficient.

Moreover, unpleasant flavor remains after eating due to the effect of bitterness of sodium caseinate and the phosphate. To mask the bitterness, seasoning must be used in an excessive amount and, as the result, the proper flavor of meat is lost. The content of the emulsion in the product must be restricted within a narrow range since the flavor of the emulsion is excessively intense and the phosphate exhibits the adverse effect. Therefore, the type of the beef which can be used as the raw material is restricted and, moreover, the control of the juicy property is difficult.

### SUMMARY OF THE INVENTION

The present invention has an object of overcoming the problems of the emulsion used for producing the marbled beef and providing an emulsion for processed meat which exhibits an excellent emulsifying property, stability in a wide range of temperatues, fluidity at low temperatures and flavor and is advantageously used for producing meat having excellent color, texture (feel of fiber and feel to teeth), flavor and aftertaste and a processed meat which is obtained by using the above emulsion and has the above advantageous properties.

As the result of intensive studies by the present inventors to achieve the above object, it was found that an emulsion containing oil and fat of animal and plant, a specific type of emulsifier, a specific type of amino acid and, occasionally, a specific type of emulsion stabilizer and an alkali salt is suitable for the object as the emulsion for processed meat and that a processed meat having the desired quality can be obtained by uniformly dispersing the emulsion into meat. The present invention has been completed based on the knowledge.

The present invention provides:

(1) An emulsion for processed meat which comprises (A) oil and fat of animal and plant, (B) at least one substance selected from (a) at least one compound selected from sucrose fatty acid esters, monoglycerides, polyglycerides and lecithins and (b) at least one substance selected from proteins of animals and plants, hydrolysis proteins and enzyme decomposed proteins, and (C) at least one compound selected from basic amino acids and salts thereof;

(2) An emulsion described in (1), which further comprises (D) an emulsion stabilizer based on a polysaccharide;

(3) An emulsion described in any one of (1) and (2), which further comprises (E) an alkali salt;

(4) An emulsion described in any one of (1), (2) and (3), wherein component (C) is at least one compound selected from L-arginine, L-lysine, L-histidine, L-proline, L-arginine L-glutamate and salts thereof;

(5) An emulsion described in any one of (3) and (4), wherein component (E) is at least one compound selected from sodium carbonate, potassium carbonate, sodium citrate and sodium malate;

(6) An emulsion described in any one of (1) to (5), wherein an amount of component (a) of component (B) is 0.01 to 10 parts by weight, an amount of component (b) of component (B) is 0.05 to 100 parts by weight and an amount of component (C) is 0.05 to 30 parts by weight per 100 parts by weight of component (A);

(7) An emulsion described in any one of (2) to (6), which comprises 0.01 to 100 parts by weight of component (D) per 100 parts by weight of component (A);

(8) An emulsion described in any one of (3) to (7), which comprises 0.05 to 30 parts by weight of component (E) per 100 parts by weight of component (A);

(9) An emulsion described in any one of (1) to (8), wherein a content of solid substances is 15 to 85% by weight;

(10) A processed meat comprising an emulsion for processed meat described in any one of (1) to (9) which is uniformly distributed in the meat;

(11). A processed meat described in (10), which comprises 5 to 30 parts by weight of the emulsion for processed meat per 100 parts by weight of meat which is uniformly distributed in meat; and

(12) A processed meat described in any one of (10) and (11), wherein the emulsion for processed meat is uniformly dispersed into meat in accordance with at least one of a process of injecting the emulsion for processed meat into meat and a process of mechanically loosening meat.

### DESCRIPTION OF THE PREFERRED EMBODIMENTS

The emulsion for processed meat of the present invention will be described in the following.

The emulsion for processed meat of the present invention comprises, as the essential components, oil and fat of animal and plant as component (A), an emulsifier as component (B) and a basic amino acid or a salt thereof as component (C). The oil and fat of animal and plant of component (A) are not particularly limited. Suitable oils and fats can be selected from oil and fat of animal and plant which can be used as food. The oils and fats may be in the solid form or in the liquid form.

Examples of the oil and fat of animal used in the present invention include tallow, lard and fish oils. Examples of the oil and fat of plant include rapeseed oil, soybean oil, palm oil, olive oil, coconut oil, rice oil and corn oil. Hardened oils, fractionated oils and transesterified oils obtained from the above natural oils and fats can be used as long as these oils and fats can be used as food.

In the present invention, the oil and fat may be used as component (A) singly or in combination of two or more. When the obtained emulsion is used for processing beef, oils and fats containing tallow are preferable. When these oils and fats are used for processing pork, oils and fats containing lard is preferable.

In the present invention, as the emulsifier of component (B) described above, at least one of component (a) and component (b) which are described in the following is used. As the emulsifier of component (a), at least one compound selected from sucrose fatty acid esters, monoglycerides, polyglycerides and lecithins is used. Examples of the sucrose fatty acid esters include esters of sucrose with higher fatty acids such as stearic acid, palmitic acid and oleic acid which are approved as the food additives. Examples of the monoglyceride include various types of monoglycerol esters of fatty acids and monoglyceride of diacetyltartaric acid which are approved as the food additives. Examples of the polyglyceride include monoesters of polyglycerols obtained by condensation with dehydration of glycerol with higher fatty acids such as myristic acid, palmitic acid, stearic acid and oleic acid which are approved as the food additives. The lecithin is not particularly limited and any of soybean lecithin, yolk lecithin and enzymatic decomposition products of these lecithins can be used. The emulsifier of component (a) may be used singly or in combination of two or more.

As the emulsifier of component (b), at least one substance selected from proteins of animals and plants, hydrolysis protein and enzyme decomposed protein is used. Examples of the proteins of animals and plants, hydrolysis protein and enzyme decomposed protein include whey protein concentrates (WPC), hydrolysis milk protein and enzyme decomposed milk protein, collagen protein, egg white, soybean protein isolates, wheat protein, blood plasma protein, whey protein isolates (WPI), sodium caseinate, hydrolysis collagen and enzyme decomposed collagen, hydrolysis egg protein and enzyme decomposed egg protein, concentrated soybean protein and soluble gelatin. The proteins of animals and plants, hydrolysis protein and enzyme decomposed protein may be used singly or in combination of two or more.

In the present invention, as the emulsifier of component (B), component (a) described above may be used alone, component (b) described above may be used alone or component (a) and component (b) may be used in combination. In particular, when component (a) and component (b) is used in combination, excellent emulsifying ability can be exhibited due to the synergistic effect.

Examples of the basic amino acid and the salt of the basic amino acid used as component (C) include L-arginine, L-lysine, L-histidine, L-proline, L-arginine L-glutamate and salts of these amino acids. L-Lysine is, in general, used in the form of the salt of hydrochloric acid. The basic amino acid and the salt of the basic amino acid may be used singly or in combination of two or more. By the use of the basic amino acid or the salt of the basic amino acid of component (C), an emulsion exhibiting excellent properties can be obtained due to the synergistic effect with component (B) and, in particular, with component (a) of component (B). When this emulsion is used for processed meat, processed meat having excellent color, texture, flavor and aftertaste can be obtained. From the standpoint of the above effects, L-arginine and L-lysine hydrochloride are preferable.

The components in the emulsion are used in the following amounts. When the emulsifier of component (a) of component (B) is used singly, component (a) is used in an amount, in general, in the range of 0.01 to 10 parts by weight, preferably in the range of 0.05 to 7 parts by weight and more preferably in the range of 0.1 to 5 parts by weight per 100 parts by weight of the oil and fat of animal and plant of component (A). When the emulsifier of component (b) of component (B) is used singly, component (b) is used in an amount, in general, in the range of 0.05 to 100 parts by weight, preferably in the range of 0.5 to 50 parts by weight and more preferably in the range of 1 to 10 parts by weight per 100 parts by weight of component (A). The basic amino acid or the salt of the basic amino acid of component (C) is used in an amount, in general, in the range of 0.05 to 30 parts by weight, preferably in the range of 0.5 to 20 parts by weight and more preferably in the range of 2 to 10 parts by weight per 100 parts by weight of component (A). When component (a) of component (B) is used singly in an amount smaller than 0.01 parts by weight, the emulsifying property cannot be exhibited sufficiently. When component (a) is used singly in an amount exceeding 10 parts by weight, the emulsifying property is not improved to the degree expected from the used amount and there is the possibility that the quality of the emulsion deteriorates. When component (b) of component (B) is used singly in an amount smaller than 0.05 parts by weight, the emulsifying property cannot be exhibited sufficiently. When component (b) is used singly in an amount exceeding 100 parts by weight, the emulsifying property is not improved to the degree expected from the used amount and the quality of the emulsion deteriorates. When component (a) and component (b) are used in combination, the amounts of component (a) and component (b) may be smaller than the amounts in the single use within the above ranges and can be suitably adjusted in accordance with the relative amounts of the components. When the amount of component (C) is smaller than 0.05 parts by weight or exceeds 30 parts by weight, it is difficult that an emulsion having a satisfactory quality is obtained.

Where desired, the emulsion for processed meat of the present invention may further comprise an emulsion stabilizer based on a polysaccharide as component (D) and/or an alkali salt as component (E) so that the quality of the emulsion is improved.

Examples of the emulsion stabilizer based on a polysaccharide of component (D) include carrageenan, xanthane gum, tamarind gum, gellan gum, agar and lipophilic starch. The emulsion stabilizer based on a polysaccharide may be used singly or in combination of two or more. By adding the emulsion stabilizer based on a polysaccharide of component (D) into the emulsion, deterioration in the emulsifying property with time can be suppressed and the amount of the emulsifier of component (B) can be decreased. The component (D) is used in an amount, in general, in the range of 0.01 to 100 parts by weight, preferably in the range of 0.01 to 50 and more preferably in the range of 0.01 to 10 parts by weight per 100 parts by weight of the oil and fat of animal and plant of component (A). When the amount is smaller than 0.01 part by weight, the effect of adding component (D) is not sufficiently exhibited. When the amount exceeds 100 parts by weight, the effect is not exhibited to the degree expected from the added amount and the quality of the emulsion deteriorates.

The alkali salt of component (E) is not particularly limited and any alkali salt can be used as long as the alkali salt can be used for food. Preferable examples of the alkali salt include salts such as sodium carbonate, potassium carbonate, sodium citrate and sodium malate. However, phosphates are excluded. The alkali salt may be used singly or in combination of two or more. By adding the alkali salt to the emulsion, feel of fiber, color, feel to teeth and flavor are improved when the emulsion is used for processed meat. Phosphates are not preferable as the alkali salt as described above. Component (E) is used in an amount, in general, in the range of 0.05 to 30 parts by weight, preferably in the range of 0.5 to 20 and more preferable in the range of 2 to 10 parts by weight per 100 parts by weight of the oil and fat of animal and plant of component (A). When the amount is smaller than 0.05 parts by weight, there is the possibility that the effect of adding component (E) is not sufficiently exhibited. When the amount exceeds 30 parts by weight, the effect is not exhibited to the degree expected from the added amount and the quality of the emulsion deteriorates.

Where desired, the emulsion for processed meat of the present invention may further comprise amino acids having sulfur such as L-cystine and L-methionine to improve color of meat and seasonings such beef extracts to improve flavor and aftertaste as long as the object of the present invention is not adversely affected.

The concentration of solid substances in the emulsion for processed meat of the present invention is not particularly limited. From the standpoint of stability of the emulsion, handling and whiteness, the concentration of solid substances is selected, in general, in the range of 15 to 85% by weight, preferably in the range of 25 to 80% by weight and more preferable in the range of 40 to 70% by weight.

The process for producing the emulsion for processed meat is not particularly limited and any of conventional processes for producing an emulsion containing oils and fats can be used. For example, component (B), component (C) and, where desired, component (D), component (E) and other additive components are dissolved or dispersed in water and an aqueous phase is prepared. The prepared aqueous phase and the oil and fat of animal and plant of component (A) are mixed together and emulsified and a homogenous emulsion is prepared. The process for emulsification is not particularly limited and a conventional process for preparing a homogeneous emulsion used in the field of food can be used. For example, the aqueous phase and the oil phase are mixed together by stirring and a preliminary emulsion is prepared. The preliminary emulsion is treated for emulsification by a homogenizer, a colloid mill or a homomixer and a homogeneous emulsion is prepared.

Alternatively, component (A), component (B), component (C) and, where desired, component (D), component (E) and other additive components are added to water in prescribed relative amounts and a preliminary emulsion is prepared. The preliminary emulsion is treated for emulsification by a homogenizer, a colloid mill or a homomixer and a homogeneous emulsion is prepared.

In the above processes, the emulsification may be conducted under beating at a suitable temperature.

The emulsion for processed meat of the present invention exhibits excellent emulsifying property, stability of the emulsion in a wide range of the temperature, fluidity at low temperatures and flavor and can be used for processed meat in various fields.

The processed meat of the present invention is described in the following.

The processed meat of the present invention is prepared by uniformly dispersing the emulsion for processed meat of the present invention into meat. The processed meat has excellent color, texture (feel of fiber and feel to teeth), flavor and aftertaste and has an improved quality of soft meat. In the process for producing the processed meat, the process for uniformly dispersing the emulsion into the meat is not particularly limited and various processes can be used. For example, a process comprising injecting the emulsion for processed meat into meat and a process comprising mechanically loosening meat can be preferably used. In the above process of injection, using an injector having many needles, the needles separated by a suitable distance such as 5 to 10 mm between the needles are inserted into the meat through the surface and the emulsion is injected through the needles. In the above process of mechanical loosening, the emulsion is injected into meat in accordance with a suitable method and the meat containing the emulsion is mechanically loosened by using a machine such as a rotary massaging machine. In the present invention, the process of injection and the process of mechanical loosening may be used in combination.

The amount of the emulsion injected into meat can be suitably selected in accordance with the desired content of fat in the processed meat of the product. The amount is, in general, in the range of 5 to 30 parts by weight and preferably in the range of 10 to 25 parts by weight per 100 parts by weight of meat.

As described above, by using the emulsion for processed meat of the present invention, processed meat exhibiting excellent color, texture (feel of fiber and feel to teeth), flavor and aftertaste and having a quality of soft meat can be obtained. The emulsion can be distributed in meat in a manner such that marble-like appearance is exhibited and, therefore, the marbled beef can be produced easily, where desired.

To summarize the advantages of the present invention, the emulsion for processed meat of the present invention exhibits excellent emulsifying property, stability of emulsion in a wide range of temperature, fluidity at low temperatures and flavor and can be advantageously used for processed meat. The processed meat obtained by using the emulsion of the present invention exhibits excellent color, texture (feel of fiber and feel to teeth), flavor and aftertaste.

### EXAMPLES

The present invention will be described more specifically with reference to examples in the following. However, the present invention is not limited to the examples.

The properties of emulsions and processed meats obtained in the examples were evaluated in accordance with the following methods.

<Emulsion>

(1) Emulsifying property and stability of an emulsion

(a) Into a 100 ml measuring cylinder, 100 ml of an emulsion immediately after emulsification was placed. After the emulsion was left standing at the room temperature (20° C.) for 5 minutes, the volume of the separated oil phase was measured. The volume fraction of the separated oil phase in the entire emulsion was obtained and the stability of the emulsion was evaluated in accordance with the following criterion having 10 grades.

(b) Into a 100 ml measuring cylinder, 100 ml of an emulsion immediately after emulsification was placed. After the emulsion was left standing at the room temperature (20° C.) for 24 hours, at 40° C. for 24 hours and at 60° C. for 24 hours, the volume of the separated oil phase was measured. The volume fraction of the separated oil phase in the entire emulsion was obtained and the stability of the emulsion was evaluated in accordance with the following criterion having 10 grades.

| | |
|---|---|
| 10 points: | The volume fraction was 0% or greater and smaller |
| | than 3%. |
| 9 points: | The volume fraction was 3% or greater and smaller |
| | than 5%. |
| 8 points: | The volume fraction was 5% or greater and smaller |
| | than 10%. |
| 7 points: | The volume fraction was 10% or greater and smaller |
| | than 15%. |
| 6 points: | The volume fraction was 15% or greater and smaller |
| | than 20%. |
| 5 points: | The volume fraction was 20% or greater and smaller |
| | than 25%. |
| 4 points: | The volume fraction was 25% or greater and smaller |
| | than 30%. |
| 3 points: | The volume fraction was 30% or greater and smaller |
| | than 35%. |
| 2 points: | The volume fraction was 35% or greater and smaller |
| | than 40%. |
| 1 point: | The volume fraction was 40% or greater |

(2) Flavor

Using an emulsion immediately after emulsification, smell and taste were each examined in accordance with the sensory test by 10 members. The result was evaluated in accordance with the following criterion having 5 grades and the total of the evaluation point of smell and the evaluation point of texture was evaluated in 10 grades.

| | |
|---|---|
| 5 points: | excellent |
| 4 points: | good |
| 3 points: | fair |
| 2 points: | poor |
| 1 point: | very poor |

<Processed meat>

(3) Feel of fiber, color, feel to teeth and flavor

Using cooked beef steak, the feel of fiber, the color, the feel to teeth and the flavor were examined in accordance with the sensory test by 10 members. The result was evaluated in accordance with the following criterion having 5 grades.

| | |
|---|---|
| 5 points: | excellent |
| 4 points: | good |
| 3 points: | fair |
| 2 points: | poor |
| 1 point: | very poor |

### Examples 1 to 16

(1) Preparation of emulsions

To 40 parts by weight of warm water at 50 to 60° C., components of the types shown in Table 1 were added in the amounts shown in Table 1. The resultant mixture was stirred and a homogeneous aqueous solution was prepared. To the prepared solution, 60 parts by weight of a mixed oil and fat containing tallow and a plant oil (rapeseed oil) in amounts such that the ratio of the amounts by weight was 10:8 was added. The resultant mixture was emulsified by stirring for 5 minutes and, in this manner, emulsions shown in Table 1 were prepared. The emulsification was conducted by using a stirrer [COMMERCIAL BAR BLENDERS MODEL 911; manufactured by HAMILTON BEACH/PROCTOR-SILEX, Inc.] rotated at a speed of 15,000 rpm.

The properties of the emulsions are shown in Table 1.

(2) Preparation of processed meats

Frozen thigh meat of a Holstein which has born calves was defrosted until the temperature at the center reached 1° C. Into the defrosted meat, the emulsion prepared in (1) described above in an amount of 20 parts by weight per 100 parts by weight of the meat was injected by an injector equipped with many needles. Then, the tumbling operation using a rotary massaging machine was conducted, the meat was preformed into a shape of a rod and the preformed meat was frozen and kept at −30° C.

The meats prepared as described above were warmed to −5° C. and sliced. The obtained meats for steak were cooked and beef steaks were prepared.

The properties of the beef steaks are shown in Table 1.

TABLE 1 - 1

| Example | 1 | 2 | 3 | 4 | 5 | 6 |
|---|---|---|---|---|---|---|
| Components of | | | | | | |
| emulsion (part | | | | | | |
| by weight) | | | | | | |
| component (B) | | | | | | |
| (a) | | | | | | |
| type | sucrose | sucrose | sucrose | mono- | mono- | mono- |
| | fatty | fatty | fatty | glycer- | glycer- | glycer- |
| | acid | acid | acid | ide | ide | ide |
| | ester | ester | ester | | | |
| amount | 0.1 | 0.5 | 1.0 | 0.1 | 0.5 | 1.0 |
| component (C) | | | | | | |
| type | arginine | arginine | arginine | arginine | arginine | arginine |
| amount | 1.0 | 1.0 | 1.0 | 1.0 | 1.0 | 1.0 |
| Properties of | | | | | | |
| emulsion | | | | | | |
| emulsifying | 6 | 7 | 8 | 7 | 8 | 8 |
| property | | | | | | |
| stability of | 6 | 6 | 6 | 6 | 6 | 6 |
| emulsion | | | | | | |
| flavor | 5 | 4 | 3 | 8 | 7 | 6 |
| total evaluation | 5.7 | 5.7 | 5.7 | 7.0 | 7.0 | 6.7 |
| Properties of | | | | | | |
| processed meat | | | | | | |
| feel of fiber | 3 | 3 | 3 | 3 | 3 | 3 |
| color | 4 | 4 | 4 | 4 | 5 | 5 |
| feel to teeth | 3 | 3 | 3 | 3 | 3 | 3 |
| flavor | 3 | 3 | 2 | 3 | 3 | 3 |
| total evaluation | 3.3 | 3.3 | 3.0 | 3.3 | 3.5 | 3.5 |

(Oil: 60 parts by weight; water: 40 parts by weight)

TABLE 1 - 2

| Example | 7 | 8 | 9 | 10 | 11 | 12 |
|---|---|---|---|---|---|---|
| Components of | | | | | | |
| emulsion (part | | | | | | |
| by weight) | | | | | | |
| component (B) | | | | | | |
| (a) | | | | | | |
| type | poly- | poly- | poly- | lecithin | lecithin | lecithin |
| | glycer- | glycer- | glycer- | | | |
| | ide | ide | ide | | | |
| amount | 0.1 | 0.5 | 1.0 | 0.1 | 0.5 | 1.0 |
| component (C) | | | | | | |
| type | arginine | arginine | arginine | arginine | arginine | arginine |
| amount | 1.0 | 1.0 | 1.0 | 1.0 | 1.0 | 1.0 |
| Properties of | | | | | | |
| emulsion | | | | | | |
| emulsifying | 7 | 8 | 8 | 6 | 6 | 7 |
| property | | | | | | |
| stability of | 6 | 6 | 6 | 5 | 5 | 5 |
| emulsion | | | | | | |
| flavor | 8 | 7 | 6 | 5 | 4 | 3 |
| total evaluation | 7.0 | 7.0 | 6.7 | 5.3 | 5.0 | 5.0 |
| Properties of | | | | | | |
| processed meat | | | | | | |
| feel of fiber | 3 | 3 | 3 | 3 | 3 | 3 |
| color | 4 | 5 | 5 | 4 | 4 | 3 |
| feel to teeth | 3 | 3 | 3 | 3 | 3 | 3 |
| flavor | 3 | 3 | 3 | 3 | 3 | 2 |
| total evaluation | 3.3 | 3.3 | 3.5 | 3.3 | 3.3 | 2.8 |

(Oil: 60 parts by weight; water: 40 parts by weight)

TABLE 1 - 3

| Example | 13 | 14 | 15 | 16 |
|---|---|---|---|---|
| Components of emulsion (part by weight) | | | | |
| component (B) (a) | | | | |
| type | sucrose fatty | mono- | poly- | lecithin |
| | acid ester | glyceride | glyceride | |
| amount | 0.5 | 0.5 | 0.5 | 0.5 |
| component (C) | | | | |
| type | lysine | lysine | lysine | lysine |
| | hydrochloride | hydrochloride | hydrochloride | hydrochloride |
| amount | 1.0 | 1.0 | 1.0 | 1.0 |
| Properties of emulsion | | | | |
| emulsifying property | 7 | 8 | 8 | 6 |
| stability of emulsion | 6 | 6 | 6 | 5 |
| flavor | 4 | 7 | 7 | 4 |
| total evaluation | 5.7 | 7.0 | 7.0 | 5.0 |
| Properties of processed meat | | | | |
| feel of fiber | 3 | 3 | 3 | 3 |
| color | 4 | 5 | 5 | 4 |
| feel to teeth | 3 | 3 | 3 | 3 |
| flavor | 3 | 3 | 3 | 3 |
| total evaluation | 3.3 | 3.5 | 3.5 | 3.3 |

Notes:
Sucrose fatty acid ester: a sucrose fatty acid ester (HLB-15)
Monoglyceride: diacetyltartaric acid monoglyceride
Polyglyceride: polyglycerol monostearate
Lecithin: soybean lecithin

### Examples 17 to 44

(1) Preparation of emulsions

To 40 parts by weight of warm water at 50 to 60° C., components of the types shown in Table 2 were added in the amounts shown in Table 2. The resultant mixture was stirred and a homogeneous aqueous solution was prepared. To the prepared solution, 60 parts by weight of a mixed oil and fat containing tallow and a plant oil (rapeseed oil) in amounts such that the ratio of the amounts by weight was 10:8 was added. The resultant mixture was emulsified by stirring for 5 minutes and, in this manner, emulsions shown in Table 2 were prepared. The emulsification was conducted by using a stirrer [COMMERCIAL BAR BLENDERS MODEL 911; manufactured by HAMILTON BEACH/PROCTOR-SILEX, Inc.] rotated at a speed of 15,000 rpm.

The properties of the emulsions are shown in Table 2.

(2) Preparation of processed meats

Using the emulsions prepared in (1) described above, processed meats were prepared in accordance with the same procedures as those conducted in Examples 1 to 16. The prepared meats were cooked and beef steaks were prepared. The properties of the beef steaks are shown in Table 2.

TABLE 2 - 1

| Example | 17 | 18 | 19 | 20 | 21 | 22 |
|---|---|---|---|---|---|---|
| Components of | | | | | | |
| emulsion (part | | | | | | |
| by weight) | | | | | | |
| component (B) | | | | | | |
| (b) | | | | | | |
| type | WPC | WPC | WPC | WPC | hy- | hy- |
| | | | | | drolysis | drolysis |
| | | | | | milk | milk |
| | | | | | protein | protein |
| amount | 0.5 | 1.0 | 3.0 | 5.0 | 0.5 | 1.0 |
| component (C) | | | | | | |
| type | arginine | arginine | arginine | arginine | arginine | arginine |
| amount | 1.0 | 1.0 | 1.0 | 1.0 | 1.0 | 1.0 |
| Properties of | | | | | | |
| emulsion | | | | | | |
| emulsifying | 4 | 5 | 5 | 5 | 5 | 6 |
| property | | | | | | |
| stability of | 4 | 5 | 5 | 5 | 4 | 5 |
| emulsion | | | | | | |
| flavor | 9 | 8 | 8 | 7 | 9 | 8 |
| total evaluation | 5.7 | 6.0 | 6.0 | 5.7 | 6.0 | 6.3 |
| Properties of | | | | | | |
| processed meat | | | | | | |
| feel of fiber | 3 | 3 | 3 | 3 | 3 | 3 |
| color | 4 | 4 | 4 | 3 | 4 | 4 |
| feel to teeth | 2 | 3 | 3 | 3 | 2 | 3 |
| flavor | 3 | 3 | 3 | 2 | 3 | 3 |
| total evaluation | 3.0 | 3.3 | 3.3 | 2.8 | 3.0 | 3.0 |

(Oil: 60 parts by weight; water: 40 parts by weight)

TABLE 2 - 2

| Example | 23 | 24 | 25 | 26 | 27 | 28 |
|---|---|---|---|---|---|---|
| Components of | | | | | | |
| emulsion (part | | | | | | |
| by weight) | | | | | | |
| component (B) | | | | | | |
| (b) | | | | | | |
| type | hy- | hy- | egg | egg | egg | egg |
| | drolysis | drolysis | white | white | white | white |
| | milk | milk | | | | |
| | protein | protein | | | | |
| amount | 3.0 | 5.0 | 0.5 | 1.0 | 3.0 | 5.0 |
| component (C) | | | | | | |
| type | arginine | arginine | arginine | arginine | arginine | arginine |
| amount | 1.0 | 1.0 | 1.0 | 1.0 | 1.0 | 1.0 |
| Properties of | | | | | | |
| emulsion | | | | | | |
| emulsifying | 6 | 7 | 5 | 5 | 6 | 6 |
| property | | | | | | |
| stability of | 5 | 6 | 5 | 6 | 6 | 6 |
| emulsion | | | | | | |
| flavor | 8 | 7 | 9 | 7 | 6 | 5 |
| total evaluation | 6.3 | 6.7 | 6.3 | 6.0 | 6.0 | 5.7 |
| Properties of | | | | | | |
| processed meat | | | | | | |
| feel of fiber | 3 | 3 | 3 | 3 | 3 | 3 |
| color | 4 | 3 | 4 | 4 | 4 | 3 |
| feel to teeth | 3 | 3 | 2 | 3 | 3 | 3 |
| flavor | 3 | 2 | 3 | 3 | 3 | 2 |
| total evaluation | 3.3 | 2.8 | 3.0 | 3.3 | 3.3 | 2.8 |

(Oil: 60 parts by weight; water: 40 parts by weight)

TABLE 2 - 3

| Example | 29 | 30 | 31 | 32 | 33 | 34 |
|---|---|---|---|---|---|---|
| Components of | | | | | | |
| emulsion (part | | | | | | |
| by weight) | | | | | | |
| component (B) | | | | | | |
| (b) | | | | | | |
| type | WPI | WPI | WPI | WPI | enzyme | enzyme |
| | | | | | decom- | decom- |
| | | | | | posed | posed |
| | | | | | collagen | collagen |
| amount | 0.5 | 1.0 | 3.0 | 5.0 | 0.5 | 1.0 |
| component (C) | | | | | | |
| type | arginine | arginine | arginine | arginine | arginine | arginine |
| amount | 1.0 | 1.0 | 1.0 | 1.0 | 1.0 | 1.0 |
| Properties of | | | | | | |
| emulsion | | | | | | |
| emulsifying | 5 | 6 | 6 | 7 | 5 | 6 |
| property | | | | | | |
| stability of | 4 | 5 | 5 | 6 | 4 | 6 |
| emulsion | | | | | | |
| flavor | 9 | 8 | 8 | 7 | 9 | 8 |
| total evaluation | 6.0 | 6.3 | 6.3 | 6.7 | 6.0 | 6.7 |
| Properties of | | | | | | |
| processed meat | | | | | | |
| feel of fiber | 3 | 3 | 3 | 3 | 3 | 3 |
| color | 4 | 4 | 4 | 3 | 4 | 4 |
| feel to teeth | 2 | 3 | 3 | 3 | 2 | 3 |
| flavor | 3 | 3 | 3 | 2 | 3 | 3 |
| total evaluation | 3.0 | 3.3 | 3.3 | 2.8 | 3.0 | 3.3 |

(Oil: 60 parts by weight; water: 40 parts by weight)

TABLE 2 - 4

| Example | 35 | 36 | 37 | 38 | 39 | 40 |
|---|---|---|---|---|---|---|
| Components of | | | | | | |
| emulsion (part | | | | | | |
| by weight) | | | | | | |
| component (B) | | | | | | |
| (b) | | | | | | |
| type | enzyme | enzyme | WPC | hy- | egg | WPI |
| | decom- | decom- | | drolysis | white | |
| | posed | posed | | milk | | |
| | collagen | collagen | | protein | | |
| amount | 3.0 | 5.0 | 1.0 | 1.0 | 1.0 | 1.0 |
| component (C) | | | | | | |
| type | arginine | arginine | lysine | lysine | lysine | lysine |
| | | | hydro- | hydro- | hydro- | hydro- |
| | | | chloride | chloride | chloride | chloride |
| amount | 1.0 | 1.0 | 1.0 | 1.0 | 1.0 | 1.0 |
| Properties of | | | | | | |
| emulsion | | | | | | |
| emulsifying | 6 | 7 | 5 | 6 | 5 | 6 |
| property | | | | | | |
| stability of | 6 | 6 | 5 | 5 | 6 | 5 |
| emulsion | | | | | | |
| flavor | 8 | 7 | 8 | 8 | 7 | 8 |
| total evaluation | 6.7 | 6.7 | 6.0 | 6.3 | 6.0 | 6.3 |
| Properties of | | | | | | |
| processed meat | | | | | | |
| feel of fiber | 3 | 3 | 3 | 3 | 3 | 3 |
| color | 4 | 3 | 4 | 4 | 4 | 4 |
| feel to teeth | 3 | 3 | 3 | 3 | 3 | 3 |
| flavor | 3 | 2 | 3 | 3 | 3 | 3 |
| total evaluation | 3.3 | 2.8 | 3.3 | 3.3 | 3.3 | 3.3 |

(Oil: 60 parts by weight; water: 40 parts by weight)

TABLE 2 - 5

| Example | 41 | 42 | 43 | 44 |
|---|---|---|---|---|
| Components of emulsion (part by weight) | | | | |
| component (B) (b) | | | | |
| type | enzyme | enzyme | enzyme | enzyme |
| | decomposed | decomposed | decomposed | decomposed |
| | collagen | collagen | collagen | collagen |
| amount | 0.5 | 1.0 | 3.0 | 5.0 |
| component (C) | | | | |
| type | lysine | lysine | lysine | lysine |
| | hydrochloride | hydrochloride | hydrochloride | hydrochloride |
| amount | 1.0 | 1.0 | 1.0 | 1.0 |
| Properties of emulsion | | | | |
| emulsifying property | 5 | 6 | 6 | 7 |
| stability of emulsion | 4 | 6 | 6 | 6 |
| flavor | 9 | 8 | 8 | 7 |
| total evaluation | 6.0 | 6.7 | 6.7 | 6.7 |
| Properties of processed meat | | | | |
| feel of fiber | 3 | 3 | 3 | 3 |
| color | 4 | 4 | 4 | 3 |
| feel to teeth | 2 | 3 | 3 | 3 |
| flavor | 3 | 3 | 3 | 2 |
| total evaluation | 3.0 | 3.5 | 3.3 | 2.8 |

Notes:
(Oil: 60 parts by weight; water: 40 parts by weight)
Amino acids: all L-isomers

### Examples 45 to 68

(1) Preparation of emulsions

To 40 parts by weight of warm water at 50 to 60° C., components of the types shown in Table 3 were added in the amounts shown in Table 3. The resultant mixture was stirred and a homogeneous aqueous solution was prepared. To the prepared solution, 60 parts by weight of a mixed oil and fat containing tallow and a plant oil (rapeseed oil) in amounts such that the ratio of the amounts by weight was 10:8 was added. The resultant mixture was emulsified by stirring for 5 minutes and, in this manner, emulsions shown in Table 3 were prepared. The emulsification was conducted by using a stirrer [COMMERCIAL BAR BLENDERS MODEL 911, manufactured by HAMILTON BEACH/PROCTOR-SILEX, Inc.] rotated at a speed of 15,000 rpm.

The properties of the emulsions are shown in Table 3.

(2) Preparation of processed meats

Using the emulsions prepared in (1) described above, processed meats were prepared in accordance with the same procedures as those conducted in Examples 1 to 16. The prepared meats were cooked and beef steaks were prepared. The properties of the beef steaks are shown in Table 3.

TABLE 3 - 1

| Example | 45 | 46 | 47 | 48 | 49 | 50 |
|---|---|---|---|---|---|---|
| Components of | | | | | | |
| emulsion (part | | | | | | |
| by weight) | | | | | | |
| component (B) | | | | | | |
| (a) | | | | | | |
| type | mono- | mono- | mono- | mono- | mono- | mono- |
| | glycer- | glycer- | glycer- | glycer- | glycer- | glycer- |
| | ide | ide | ide | ide | ide | ide |
| amount | 0.5 | 0.5 | 0.5 | 0.5 | 0.5 | 0.5 |
| component (B) | | | | | | |
| (b) | | | | | | |
| type | WPI | WPI | hy- | hy- | egg | egg |
| | | | drolysis | drolysis | white | white |
| | | | milk | milk | | |
| | | | protein | protein | | |
| amount | 0.5 | 3.0 | 0.5 | 3.0 | 0.5 | 3.0 |
| component (C) | | | | | | |
| type | arginine | arginine | arginine | arginine | arginine | arginine |
| amount | 1.0 | 1.0 | 1.0 | 1.0 | 1.0 | 1.0 |
| Properties of | | | | | | |
| emulsion | | | | | | |
| emulsifying | 8 | 9 | 8 | 9 | 8 | 9 |
| property | | | | | | |
| stability of | 8 | 9 | 8 | 9 | 8 | 9 |
| emulsion | | | | | | |
| flavor | 8 | 8 | 8 | 8 | 8 | 8 |
| total evaluation | 8.0 | 8.7 | 8.0 | 8.7 | 8.0 | 8.7 |
| Properties of | | | | | | |
| processed meat | | | | | | |
| feel of fiber | 3 | 4 | 3 | 4 | 3 | 4 |
| color | 5 | 5 | 5 | 5 | 5 | 5 |
| feel to teeth | 4 | 4 | 4 | 4 | 4 | 4 |
| flavor | 5 | 5 | 5 | 5 | 5 | 5 |
| total evaluation | 4.25 | 4.5 | 4.25 | 4.5 | 4.25 | 4.5 |

(Oil: 60 parts by weight; water: 40 parts by weight)

TABLE 3 - 2

| Example | 51 | 52 | 53 | 54 | 55 | 56 |
|---|---|---|---|---|---|---|
| Components of | | | | | | |
| emulsion (part | | | | | | |
| by weight) | | | | | | |
| component (B) | | | | | | |
| (a) | | | | | | |
| type | mono- | mono- | poly- | poly- | poly- | poly- |
| | glycer- | glycer- | glycer- | glycer- | glycer- | glycer- |
| | ide | ide | ide | ide | ide | ide |
| amount | 0.5 | 0.5 | 0.5 | 0.5 | 0.5 | 0.5 |
| component (B) | | | | | | |
| (b) | | | | | | |
| type | enzyme | enzyme | WPI | WPI | hy- | hy- |
| | decom- | decom- | | | drolysis | drolysis |
| | posed | posed | | | milk | milk |
| | collagen | collagen | | | protein | protein |
| amount | 0.5 | 3.0 | 0.5 | 3.0 | 0.5 | 3.0 |
| component (C) | | | | | | |
| type | arginine | arginine | arginine | arginine | arginine | arginine |
| amount | 1.0 | 1.0 | 1.0 | 1.0 | 1.0 | 1.0 |
| Properties of | | | | | | |
| emulsion | | | | | | |
| emulsifying | 8 | 9 | 8 | 9 | 8 | 9 |
| property | | | | | | |
| stability of | 8 | 9 | 8 | 9 | 8 | 9 |
| emulsion | | | | | | |
| flavor | 8 | 8 | 8 | 8 | 8 | 8 |
| total evaluation | 8.0 | 8.7 | 8.0 | 8.7 | 8.0 | 8.7 |
| Properties of | | | | | | |
| processed meat | | | | | | |
| feel of fiber | 3 | 4 | 3 | 4 | 3 | 4 |
| color | 5 | 5 | 5 | 5 | 5 | 5 |
| feel to teeth | 4 | 4 | 4 | 4 | 4 | 4 |
| flavor | 5 | 5 | 5 | 5 | 5 | 5 |
| total evaluation | 4.25 | 4.5 | 4.25 | 4.5 | 4.25 | 4.5 |

(Oil: 60 parts by weight; water: 40 parts by weight)

TABLE 3 - 3

| Example | 57 | 58 | 59 | 60 | 62 | 62 |
|---|---|---|---|---|---|---|
| Components of | | | | | | |
| emulsion (part | | | | | | |
| by weight) | | | | | | |
| component (B) | | | | | | |
| (a) | | | | | | |
| type | poly- | poly- | poly- | poly- | mono- | mono- |
| | glycer- | glycer- | glycer- | glycer- | glycer- | glycer- |
| | ide | ide | ide | ide | ide | ide |
| amount | 0.5 | 0.5 | 0.5 | 0.5 | 0.5 | 0.5 |
| component (B) | | | | | | |
| (b) | | | | | | |
| type | egg | egg | enzyme | enzyme | WPI | hy- |
| | white | white | decom- | decom- | | drolysis |
| | | | posed | posed | | milk |
| | | | collagen | collagen | | protein |
| amount | 0.5 | 3.0 | 0.5 | 3.0 | 3.0 | 3.0 |
| component (C) | | | | | | |
| type | arginine | arginine | arginine | arginine | lysine | lysine |
| | | | | | hydro- | hydro- |
| | | | | | chloride | chloride |
| amount | 1.0 | 1.0 | 1.0 | 1.0 | 1.0 | 1.0 |
| Properties of | | | | | | |
| emulsion | | | | | | |
| emulsifying | 8 | 9 | 8 | 9 | 9 | 9 |
| property | | | | | | |
| stability of | 8 | 9 | 8 | 9 | 9 | 9 |
| emulsion | | | | | | |
| flavor | 8 | 8 | 8 | 8 | 8 | 8 |
| total evaluation | 8.0 | 8.7 | 8.0 | 8.7 | 8.7 | 8.7 |
| Properties of | | | | | | |
| processed meat | | | | | | |
| feel of fiber | 3 | 4 | 3 | 4 | 4 | 4 |
| color | 5 | 5 | 5 | 5 | 5 | 5 |
| feel to teeth | 4 | 4 | 4 | 4 | 4 | 4 |
| flavor | 5 | 5 | 5 | 5 | 5 | 5 |
| total evaluation | 4.25 | 4.5 | 4.25 | 4.5 | 4.5 | 4.5 |

(Oil: 60 parts by weight; water: 40 parts by weight)

TABLE 3 - 4

| Example | 63 | 64 | 65 | 66 | 67 | 68 |
|---|---|---|---|---|---|---|
| Components of | | | | | | |
| emulsion (part | | | | | | |
| by weight) | | | | | | |
| component (B) | | | | | | |
| (a) | | | | | | |
| type | mono- | poly- | poly- | poly- | poly- | glycer- |
| | glycer- | glycer- | glycer- | glycer- | glycer- | ide |
| | ide | ide | ide | ide | ide | |
| amount | 0.5 | 0.5 | 0.5 | 0.5 | 0.5 | 0.5 |
| component (B) | | | | | | |
| (b) | | | | | | |
| type | egg | enzyme | WPI | hy- | egg | enzyme |
| | white | decom- | | drolysis | white | decom- |
| | | posed | | milk | | posed |
| | | collagen | | protein | | collagen |
| amount | 3.0 | 3.0 | 3.0 | 3.0 | 3.0 | 3.0 |
| component (C) | | | | | | |
| type | lysine | lysine | lysine | lysine | lysine | lysine |
| | hydro- | hydro- | hydro- | hydro- | hydro- | hydro- |
| | chloride | chloride | chloride | chloride | chloride | chloride |
| amount | 1.0 | 1.0 | 1.0 | 1.0 | 1.0 | 1.0 |
| Properties of | | | | | | |
| emulsion | | | | | | |
| emulsifying | 9 | 9 | 9 | 9 | 9 | 9 |
| property | | | | | | |
| stability of | 9 | 9 | 9 | 9 | 9 | 9 |
| emulsion | | | | | | |
| flavor | 8 | 8 | 8 | 8 | 8 | 8 |
| total evaluation | 8.7 | 8.7 | 8.7 | 8.7 | 8.7 | 8.7 |
| Properties of | | | | | | |
| processed meat | | | | | | |
| feel of fiber | 4 | 4 | 4 | 4 | 4 | 4 |
| color | 5 | 5 | 5 | 5 | 5 | 5 |
| feel to teeth | 4 | 4 | 4 | 4 | 4 | 4 |
| flavor | 5 | 5 | 5 | 5 | 5 | 5 |
| total evaluation | 4.5 | 4.5 | 4.5 | 4.5 | 4.5 | 4.5 |

(Oil: 60 parts by weight; water 40 parts by weight)
Notes:
Monoglyceride: diacetyltartaric acid monoglyceride
Polyglyceride: polyglycerol monostearate
Amino acids: all L-isomers

### Examples 69 to 92

(1) Preparation of emulsions

To 40 parts by weight of warm water at 50 to 60° C., components of the types shown in Table 4 were added in the amounts shown in Table 4. The resultant mixture was stirred and a homogeneous aqueous solution was prepared. To the prepared solution, 60 parts by weight of a mixed oil and fat containing tallow and a plant oil (rapeseed oil) in amounts such that the ratio of the amounts by weight was 10:8 was added. The resultant mixture was emulsified by stirring for 5 minutes and, in this manner, emulsions shown in Table 4 were prepared. The emulsification was conducted by using a stirrer [COMMERCIAL BAR BLENDERS MODEL 911; manufactured by HAMILTON BEACH/PROCTOR-SILEX, Inc.] rotated at a speed of 15,000 rpm.

The properties of the emulsions are shown in Table 4.

(2) Preparation of processed meats

Using the emulsions prepared in (1) described above, processed meats were prepared in accordance with the same procedures as those conducted in Examples 1 to 16. The prepared meats were cooked and beef steaks were prepared. The properties of the beef steaks are shown in Table 4.

TABLE 4-1

| | | | | | | |
|---|---|---|---|---|---|---|
| Example | 69 | 70 | 71 | 72 | 73 | 74 |

Components of emulsion
(part by weight)

| | | | | | | |
|---|---|---|---|---|---|---|
| component (B) (a) | | | | | | |
| type | mono- | mono- | mono- | mono- | mono- | mono- |
| | glyceride | glyceride | glyceride | glyceride | glyceride | glyceride |
| amount | 0.5 | 0.5 | 0.5 | 0.5 | 0.5 | 0.5 |
| component (B) (b) | | | | | | |
| type | enzyme | enzyme | enzyme | enzyme | enzyme | enzyme |
| | decom- | decom- | decom- | decom- | decom- | decom- |
| | posed | posed | posed | posed | posed | posed |
| | collagen | collagen | collagen | collagen | collagen | collagen |
| amount | 3.0 | 3.0 | 3.0 | 3.0 | 3.0 | 3.0 |
| component (C) | | | | | | |
| type | arginine | arginine | arginine | arginine | arginine | arginine |
| amount | 1.0 | 1.0 | 1.0 | 1.0 | 1.0 | 1.0 |
| component (D) | | | | | | |
| type | carra- | carra- | carra- | xanthane | xanthane | xanthane |
| | geenan | geenan | geenan | gum | gum | gum |
| amount | 0.01 | 0.1 | 0.5 | 0.01 | 0.1 | 0.5 |
| Properties of emulsion | | | | | | |
| emulsifying property | 9 | 10 | 10 | 9 | 10 | 10 |
| stability of emulsion | 9 | 10 | 10 | 9 | 10 | 10 |
| flavor | 8 | 8 | 8 | 8 | 8 | 8 |
| total evaluation | 8.7 | 9.3 | 9.3 | 8.7 | 9.3 | 9.3 |
| Properties of processed meat | | | | | | |
| feel of fiber | 5 | 5 | 4 | 5 | 5 | 4 |
| color | 5 | 5 | 5 | 5 | 5 | 5 |
| feel to teeth | 5 | 5 | 4 | 5 | 5 | 4 |
| flavor | 5 | 5 | 5 | 5 | 5 | 5 |
| total evaluation | 5.0 | 5.0 | 4.5 | 5.0 | 5.0 | 4.5 |

(Oil: 60 parts by weight; water: 40 parts by weight)

TABLE 4-2

| | | | | | | |
|---|---|---|---|---|---|---|
| Example | 75 | 76 | 77 | 78 | 79 | 80 |

Components of emulsion
(part by weight)

| | | | | | | |
|---|---|---|---|---|---|---|
| component (B) (a) | | | | | | |
| type | mono- | mono- | mono- | mono- | mono- | mono- |
| | glyceride | glyceride | glyceride | glyceride | glyceride | glyceride |
| amount | 0.5 | 0.5 | 0.5 | 0.5 | 0.5 | 0.5 |
| component (B) (b) | | | | | | |
| type | enzyme | enzyme | enzyme | enzyme | enzyme | enzyme |
| | decom- | decom- | decom- | decom- | decom- | decom- |
| | posed | posed | posed | posed | posed | posed |
| | collagen | collagen | collagen | collagen | collagen | collagen |
| amount | 3.0 | 3.0 | 3.0 | 3.0 | 3.0 | 3.0 |
| component (C) | | | | | | |
| type | arginine | arginine | arginine | arginine | arginine | arginine |
| amount | 1.0 | 1.0 | 1.0 | 1.0 | 1.0 | 1.0 |
| component (D) | | | | | | |
| type | tamarind | tamarind | tamarind | gellan | gellan | gellan |
| | gum | gum | gum | gum | gum | gum |
| amount | 0.01 | 0.1 | 0.5 | 0.01 | 0.1 | 0.5 |
| Properties of emulsion | | | | | | |
| emulsifying property | 9 | 10 | 10 | 9 | 10 | 10 |
| stability of emulsion | 9 | 10 | 10 | 9 | 10 | 10 |
| flavor | 8 | 8 | 8 | 8 | 8 | 8 |
| total evaluation | 8.7 | 9.3 | 9.3 | 8.7 | 9.3 | 9.3 |
| Properties of processed meat | | | | | | |
| feel of fiber | 5 | 5 | 4 | 5 | 5 | 4 |
| color | 5 | 5 | 5 | 5 | 5 | 5 |
| feel to teeth | 5 | 5 | 4 | 5 | 5 | 4 |
| flavor | 5 | 5 | 5 | 5 | 5 | 5 |
| total evaluation | 5.0 | 5.0 | 4.5 | 5.0 | 5.0 | 4.5 |

(Oil; 60 parts by weight; water: 40 parts by weight)

TABLE 4-3

| | | | | | | |
|---|---|---|---|---|---|---|
| Example | 81 | 82 | 83 | 84 | 85 | 86 |

Components of emulsion
(part by weight)

| | | | | | | |
|---|---|---|---|---|---|---|
| component (B) (a) | | | | | | |
| type | mono- | mono- | mono- | mono- | mono- | mono- |
| | glyceride | glyceride | glyceride | glyceride | glyceride | glyceride |
| amount | 0.5 | 0.5 | 0.5 | 0.5 | 0.5 | 0.5 |
| component (B) (b) | | | | | | |
| type | enzyme | enzyme | enzyme | enzyme | enzyme | enzyme |
| | decom- | decom- | decom- | decom- | decom- | decom- |
| | posed | posed | posed | posed | posed | posed |
| | collagen | collagen | collagen | collagen | collagen | collagen |
| amount | 3.0 | 3.0 | 3.0 | 3.0 | 3.0 | 3.0 |
| component (C) | | | | | | |
| type | arginine | arginine | arginine | arginine | arginine | arginine |
| amount | 1.0 | 1.0 | 1.0 | 1.0 | 1.0 | 1.0 |
| component (D) | | | | | | |
| type | agar | agar | agar | lipophilic | lipophilic | lipophilic |
| | | | | starch | starch | starch |
| amount | 0.1 | 0.5 | 1.0 | 0.5 | 1.0 | 3.0 |
| Properties of emulsion | | | | | | |
| emulsifying property | 9 | 10 | 10 | 9 | 10 | 10 |
| stability of emulsion | 9 | 10 | 10 | 9 | 10 | 10 |
| flavor | 8 | 8 | 8 | 8 | 8 | 8 |
| total evaluation | 8.7 | 9.3 | 9.3 | 8.7 | 9.3 | 9.3 |
| Properties of processed meat | | | | | | |
| feel of fiber | 4 | 4 | 5 | 4 | 4 | 5 |
| color | 5 | 5 | 5 | 5 | 5 | 5 |
| feel to teeth | 4 | 4 | 4 | 4 | 4 | 4 |
| flavor | 5 | 5 | 5 | 5 | 5 | 5 |
| total evaluation | 4.5 | 4.5 | 4.75 | 4.5 | 4.5 | 4.75 |

)Oil: 60 parts by weight; water: 40 parts by weight)

TABLE 4-4

| | | | | | | |
|---|---|---|---|---|---|---|
| Example | 87 | 88 | 89 | 90 | 91 | 92 |

Components of emulsion
(part by weight)

| | | | | | | |
|---|---|---|---|---|---|---|
| component (B) (a) | | | | | | |
| type | mono- | mono- | mono- | mono- | mono- | mono- |
| | glyceride | glyceride | glyceride | glyceride | glyceride | glyceride |
| amount | 0.5 | 0.5 | 0.5 | 0.5 | 0.5 | 0.5 |
| component (B) (b) | | | | | | |
| type | enzyme | enzyme | enzyme | enzyme | enzyme | enzyme |
| | decom- | decom- | decom- | decom- | decom- | decom- |
| | posed | posed | posed | posed | posed | posed |
| | collagen | collagen | collagen | collagen | collagen | collagen |
| amount | 3.0 | 3.0 | 3.0 | 3.0 | 3.0 | 3.0 |
| component (C) | | | | | | |
| type | lysine | lysine | lysine | lysine | lysine | lysine |
| | hydro- | hydro- | hydro- | hydro- | hydro- | hydro- |
| | chloride | chloride | chloride | chloride | chloride | chloride |
| amount | 1.0 | 1.0 | 1.0 | 1.0 | 1.0 | 1.0 |
| component (D) | | | | | | |
| type | carra- | xanthane | tamarind | gellan | agar | lipophilic |
| | geenan | gum | gum | gum | | starch |
| amount | 0.1 | 0.1 | 0.1 | 0.1 | 0.5 | 1.0 |
| Properties of emulsion | | | | | | |
| emulsifying property | 10 | 10 | 10 | 10 | 10 | 10 |
| stability of emulsion | 10 | 10 | 10 | 10 | 10 | 10 |
| flavor | 8 | 8 | 8 | 8 | 8 | 8 |
| total evaluation | 9.3 | 9.3 | 9.3 | 9.3 | 9.3 | 9.3 |
| Properties of processed meat | | | | | | |
| feel of fiber | 5 | 5 | 5 | 5 | 4 | 4 |
| color | 5 | 5 | 5 | 5 | 5 | 5 |
| feel to teeth | 5 | 5 | 5 | 5 | 4 | 4 |
| flavor | 5 | 5 | 5 | 5 | 5 | 5 |
| total evaluation | 5.0 | 5.0 | 5.0 | 5.0 | 4.5 | 4.5 |

(Oil: 60 parts by weight; water: 40 parts by weight)
Notes:
Monoglyceride: diacetyltartaric acid monoglyceride
Amino acids: all L-isomers

### Examples 93 to 98

(1) Preparation of emulsions

To 40 parts by weight of warm water at 50 to 60° C., components of the types shown in Table 5 were added in the amounts shown in Table 5. The resultant mixture was stirred and a homogeneous aqueous solution was prepared. To the prepared solution, 60 parts by weight of a mixed oil and fat containing tallow and a plant oil (rapeseed oil) in amounts such that the ratio of the amounts by weight was 10:8 was added. The resultant mixture was emulsified by stirring for 5 minutes and, in this manner, emulsions shown in Table 2 were prepared. The emulsification was conducted by using a stirrer [COMMERCIAL BAR BLENDERS MODEL 911, manufactured by HAMILTON BEACH/PROCTOR-SILEX Inc.] rotated at a speed of 15,000 rpm.

The properties of the emulsions are shown in Table 5.

(2) Preparation of processed meats

Using the emulsions prepared in (1) described above, processed meats were prepared in accordance with the same procedures as those conducted in Examples 1 to 16. The prepared meats were cooked and beef steaks were prepared. The properties of the beef steaks are shown in Table 5.

TABLE 5

| | | | | | | |
|---|---|---|---|---|---|---|
| Example | 93 | 94 | 95 | 96 | 97 | 98 |

Components of emulsion
(part by weight)

| | | | | | | |
|---|---|---|---|---|---|---|
| component (B) (a) | | | | | | |
| type | mono- | mono- | mono- | mono- | mono- | mono- |
| | glyceride | glyceride | glyceride | glyceride | glyceride | glyceride |
| amount | 0.5 | 0.5 | 0.5 | 0.5 | 0.5 | 0.5 |
| component (B) (b) | | | | | | |
| type | enzyme | enzyme | enzyme | enzyme | enzyme | enzyme |
| | decom- | decom- | decom- | decom- | decom- | decom- |
| | posed | posed | posed | posed | posed | posed |
| | collagen | collagen | collagen | collagen | collagen | collagen |
| amount | 3.0 | 3.0 | 3.0 | 3.0 | 3.0 | 3.0 |
| component (C) | | | | | | |
| type | arginine | arginine | arginine | arginine | lysine | lysine |
| | | | | | hydro- | hydro- |
| | | | | | chloride | chloride |
| amount | 1.0 | 1.0 | 1.0 | 1.0 | 1.0 | 1.0 |
| component (D) | | | | | | |
| type | carra- | carra- | carra- | carra- | carra- | carra- |
| | geenan | geenan | geenan | geenan | geenan | geenan |
| amount | 0.1 | 0.1 | 0.1 | 0.1 | 0.1 | 0.1 |
| component (E) | | | | | | |
| type | sodium | sodium | sodium | sodium | sodium | sodium |
| | carbonate | carbonate | citrate | citrate | carbonate | citrate |
| amount | 1.0 | 3.0 | 1.0 | 3.0 | 1.0 | 1.0 |
| Properties of emulsion | | | | | | |
| emulsifying property | 10 | 10 | 10 | 10 | 10 | 10 |
| stability of emulsion | 10 | 10 | 10 | 10 | 10 | 10 |
| flavor | 8 | 7 | 8 | 7 | 8 | 8 |
| total evaluation | 9.3 | 9.0 | 9.3 | 9.0 | 9.3 | 9.3 |
| Properties of processed meat | | | | | | |
| feel of fiber | 5 | 5 | 5 | 5 | 5 | 5 |
| color | 5 | 5 | 5 | 5 | 5 | 5 |
| feel to teeth | 5 | 5 | 5 | 5 | 5 | 5 |
| flavor | 5 | 4 | 5 | 4 | 5 | 5 |
| total evaluation | 5.0 | 4.75 | 5.0 | 4.75 | 5.0 | 5.0 |

(Oil: 60 parts by weight; water: 40 parts by weight)

### Examples 99 to 113

(1) Preparation of emulsions

To 40 parts by weight of warm water at 50 to 60° C., components of the types shown in Table 6 were added in the amounts shown in Table 6. The resultant mixture was stirred and a homogeneous aqueous solution was prepared. To the prepared solution, 60 parts by weight of a mixed oil and fat containing purified tallow and a plant oil (rapeseed oil) in amounts such that the ratio of the amounts by weight was 10:5 was added. The resultant mixture was emulsified by stirring for 5 minutes and, in this manner, emulsions shown in Table 6 were prepared. The emulsification was conducted by using a stirrer [COMMERCIAL BAR BLENDERS MODEL 911; manufactured by HAMILTON BEACH/PROCTOR-SILEX, Inc.] rotated at a speed of 15,000 rpm.

The properties of the emulsions are shown in Table 6.

(2) Preparation of processed meats

Using the emulsions prepared in (1) described above, processed meats were prepared in accordance with the same procedures as those conducted in Examples 1 to 16. The prepared meats were cooked and beef steaks were prepared. The properties of the beef steaks are shown in Table 6.

TABLE 6-1

| | | | | | | |
|---|---|---|---|---|---|---|
| Example | 99 | 100 | 101 | 102 | 103 | 104 |

Components of emulsion
(part by weight)

| | | | | | | |
|---|---|---|---|---|---|---|
| component (B) (a) | | | | | | |
| type | mono- | mono- | mono- | mono- | mono- | mono- |
| | glyceride | glyceride | glyceride | glyceride | glyceride | glyceride |
| amount | 0.5 | 0.5 | 0.5 | 0.5 | 0.5 | 0.5 |
| component (B) (b) | | | | | | |
| type | WPI | WPI | WPI | WPI | WPI | WPI |
| amount | 1.0 | 1.0 | 1.0 | 1.0 | 1.0 | 1.0 |
| component (C) | | | | | | |
| type | arginine | arginine | arginine | hystidine | hystidine | hystidine |
| amount | 1.3 | 3.0 | 5.0 | 1.0 | 3.0 | 5.0 |
| component (D) | | | | | | |
| type | carra- | carra- | carra- | carra- | carra- | carra- |
| | geenan | geenan | geenan | geenan | geenan | geenan |
| amount | 0.1 | 0.1 | 0.1 | 0.1 | 0.1 | 0.1 |
| component (E) | | | | | | |
| type | — | — | — | — | — | — |
| amount | — | — | — | — | — | — |
| seasoning | | | | | | |
| type | beef | beef | beef | beef | beef | beef |
| | extract | extract | extract | extract | extract | extract |
| amount | 0.3 | 0.3 | 0.3 | 0.3 | 0.3 | 0.3 |
| Properties of emulsion | | | | | | |
| emulsifying property | 10 | 10 | 10 | 10 | 10 | 10 |
| stability of emulsion | 10 | 10 | 10 | 10 | 10 | 10 |
| flavor | 10 | 10 | 9 | 10 | 10 | 9 |
| total evaluation | 10.0 | 10.0 | 9.7 | 10.0 | 10.0 | 9.7 |
| Properties of processed meat | | | | | | |
| feel of fiber | 5 | 5 | 4 | 5 | 5 | 4 |
| color | 5 | 5 | 5 | 5 | 5 | 5 |
| feel to teeth | 5 | 5 | 4 | 5 | 5 | 4 |
| flavor | 5 | 5 | 4 | 5 | 5 | 4 |
| total evaluation | 5.0 | 5.0 | 4.25 | 5.0 | 5.0 | 4.25 |

(Oil: 60 parts by weight; water: 40 parts by weight)

TABLE 6-2

| | | | | | | |
|---|---|---|---|---|---|---|
| Example | 105 | 106 | 107 | 108 | 109 | 110 |

Components of emulsion
(part by weight)

| | | | | | | |
|---|---|---|---|---|---|---|
| component (B) (a) | | | | | | |
| type | mono- | mono- | mono- | mono- | mono- | mono- |
| | glyceride | glyceride | glyceride | glyceride | glyceride | glyceride |
| amount | 0.5 | 0.5 | 0.5 | 0.5 | 0.5 | 0.5 |
| component (B) (b) | | | | | | |
| type | WPI | WPI | WPI | WPI | WPI | WPI |
| amount | 1.0 | 1.0 | 1.0 | 1.0 | 1.0 | 1.0 |
| component (C) | | | | | | |
| type | proline | proline | proline | lysine | lysine | lysine |
| | | | | hydro- | hydro- | hydro- |
| | | | | chloride | chloride | chloride |
| amount | 1.0 | 3.0 | 5.0 | 1.0 | 3.0 | 5.0 |
| component (D) | | | | | | |
| type | carra- | carra- | carra- | carra- | carra- | carra- |
| | geenan | geenan | geenan | geenan | geenan | geenan |
| amount | 0.1 | 0.1 | 0.1 | 0.1 | 0.1 | 0.1 |
| component (E) | | | | | | |
| type | — | — | — | — | — | — |
| amount | — | — | — | — | — | — |
| seasoning | | | | | | |
| type | beef | beef | beef | beef | beef | beef |
| | extract | extract | extract | extract | extract | extract |
| amount | 0.3 | 0.3 | 0.3 | 0.3 | 0.3 | 0.3 |
| Properties of emulsion | | | | | | |
| emulsifying property | 10 | 10 | 10 | 10 | 10 | 10 |
| stability of emulsion | 10 | 10 | 10 | 10 | 10 | 10 |
| flavor | 10 | 10 | 9 | 10 | 10 | 9 |
| total evaluation | 10.0 | 10.0 | 9.7 | 10.0 | 10.0 | 9.7 |
| Properties of processed meat | | | | | | |
| feel of fiber | 5 | 5 | 4 | 5 | 5 | 4 |
| color | 5 | 5 | 5 | 5 | 5 | 5 |
| feel to teeth | 5 | 5 | 4 | 5 | 5 | 4 |
| flavor | 5 | 5 | 4 | 5 | 5 | 4 |
| total evaluation | 5.0 | 5.0 | 4.25 | 5.0 | 5.0 | 4.25 |

(Oil: 60 parts by weight; water: 40 parts by weight)

TABLE 6 - 3

| Example | 111 | 112 | 113 |
|---|---|---|---|
| Components of emulsion (part by weight) | | | |
| component (B) (a) | | | |
| type | monoglyceride | monoglyceride | monoglyceride |
| amount | 0.5 | 0.5 | 0.5 |
| component (B) (b) | | | |
| type | WPI | WPI | WPI |
| amount | 1.0 | 1.0 | 1.0 |
| component (C) | | | |
| type | Arg-Glu | Arg-Glu | Arg-Glu |
| amount | 1.0 | 3.0 | 5.0 |
| component (D) | | | |
| type | carrageenan | carrageenan | carrageenan |
| amount | 0.1 | 0.1 | 0.1 |
| component (E) | | | |
| type | — | — | — |
| amount | — | — | — |
| seasoning | | | |
| type | beef extract | beef extract | beef extract |
| amount | 0.3 | 0.3 | 0.3 |
| Properties of emulsion | | | |
| emulsifying property | 10 | 10 | 10 |
| stability of emulsion | 10 | 10 | 10 |
| flavor | 10 | 10 | 9 |
| total evaluation | 10.0 | 10.0 | 9.7 |
| Properties of processed meat | | | |
| feel of fiber | 5 | 5 | 4 |
| color | 5 | 5 | 5 |
| feel to teeth | 5 | 5 | 4 |
| flavor | 5 | 5 | 4 |
| total evaluation | 5.0 | 5.0 | 4.25 |

Notes:
(Oil: 60 parts by weight; water 40 parts by weight)
Monoglyceride: diacetyltartaric acid monoglyceride
Arg-Glu: L-arginine L-glutamate
Amino acids: all L-isomers

### Comparative Examples 1 to 3

(1) Preparation of emulsions

To 40 parts by weight of warm water at 50 to 60° C., components of the types shown in Table 7 were added in the amounts shown in Table 7. The resultant mixture was stirred and a homogeneous aqueous solution was prepared. To the prepared solution, 60 parts by weight of a mixed oil and fat containing purified tallow and a plant oil (rapeseed oil) in amounts such that the ratio of the amounts by weight was 10:5 was added. The resultant mixture was emulsified by stirring for 5 minutes and, in this manner, emulsions shown in Table 7 were prepared. The emulsification was conducted by using a stirrer [COMMERCIAL BAR BLENDERS MODEL 911; manufactured by HAMILTON BEACH/PROCTOR-SILEX, Inc.] rotated at a speed of 15,000 rpm.

The properties of the emulsions are shown in Table 7.

(2) Preparation of processed meats

Using the emulsions prepared in (1) described above, processed meats were prepared in accordance with the same procedures as those conducted in Examples 1 to 16. The prepared meats were cooked and beef steaks were prepared. The properties of the beef steaks are shown in Table 7.

TABLE 7

| Comparative Example | 1 | 2 | 3 |
|---|---|---|---|
| Components of emulsion (part by weight) | | | |
| component (B) (a) | | | |
| type | monoglyceride | monoglyceride | monoglyceride |
| amount | 0.5 | 0.5 | 0.5 |
| component (B) (b) | | | |
| type | WPI | WPI | WPI |
| amount | 1.0 | 1.0 | 1.0 |
| component (C) | | | |
| type | — | — | — |
| amount | — | — | — |
| component (D) | | | |
| type | carrageenan | carrageenan | carrageenan |
| amount | 0.1 | 0.1 | 0.1 |
| component (E) | | | |
| type | sodium | sodium | sodium |
| | polyphosphate | polyphosphate | polyphosphate |
| amount | 0.1 | 0.5 | 1.0 |
| seasoning | | | |
| type | beef extract | beef extract | beef extract |
| amount | 0.3 | 0.3 | 0.3 |
| Properties of emulsion | | | |
| emulsifying property | 10 | 10 | 10 |
| stability of emulsion | 10 | 10 | 10 |
| flavor | 6 | 5 | 4 |
| total evaluation | 8.7 | 8.3 | 8.0 |
| Properties of processed meat | | | |
| feel of fiber | 3 | 2 | 1 |
| color | 2 | 2 | 2 |
| feel to teeth | 3 | 2 | 1 |
| flavor | 2 | 2 | 1 |
| total evaluation | 2.5 | 2.0 | 1.25 |

Notes:
(Oil: 60 parts by weight; water: 40 parts by weight)
Monoglyceride: diacetyltartaric acid monoglyceride

### Comparative Example 4

(1) Preparation of an emulsion

To 40 parts by weight of warm water at 50 to 60° C., 0.8 parts by weight of sodium caseinate, 0.48 parts by weight of water-soluble gelatin, 0.1 part by weight of natural gum, 0.32 part by weight of sodium polyphosphate, 0.28 parts by weight of hydrolysis protein and 0.02 parts by weight of enzyme decomposed starch were added. The resultant mixture was stirred and a homogeneous aqueous solution was prepared.

To the prepared solution, 60 parts by weight of a mixed oil and fat containing tallow and a plant oil (rapeseed oil) in amounts such that the ratio of the amounts by weight was 10:5 was added. The resultant mixture was emulsified by stirring for 5 minutes and an emulsion was prepared. The emulsification was conducted by using a stirrer [COMMERCIAL BAR BLENDERS MODEL 911; manufactured by HAMILTON BEACH/PROCTOR-SILEX, Inc.] rotated at a speed of 15,000 rpm.

The properties of the emulsion are shown in Table 8.

(2) Preparation of processed meat

Using the emulsions prepared in (1) described above, processed meats were prepared in accordance with the same procedures as those conducted in Examples 1 to 16. The prepared meats were cooked and beef steaks were prepared. The properties of the beef steaks are shown in Table 8.

TABLE 8

| | Comparative Example 4 |
|---|---|
| Properties of emulsion | |
| emulsifying property | 9 |
| stability of emulsion | 5 |
| flavor | 4 |
| total evaluation | 6.0 |
| Properties of processed meat | |
| feel of fiber | 2 |
| color | 2 |
| feel to teeth | 2 |
| flavor | 2 |
| total evaluation | 2.0 |

What is claimed is:

1. An emulsion for processed meat which comprises (A) oil and fat of animal and plant, (B) at least one substance selected from (a) at least one compound selected from sucrose fatty acid esters, monoglycerides, polyglycerides and lecithins and (b) at least one substance selected from proteins of animals and plants, hydrolysis proteins and enzyme decomposed proteins, and (C) at least one compound selected from basic amino acids and salts thereof.

2. An emulsion according to claim 1, which further comprises (D) an emulsion stabilizer based on a polysaccharide.

3. An emulsion according to claim 1, which further comprises (E) an alkali salt.

4. An emulsion according to claim 1, wherein component (C) is at least one compound selected from L-arginine, L-lysine, L-histidine, L-proline, L-arginine L-glutamate and salts thereof.

5. An emulsion according to claim 3, wherein component (E) is at least one compound selected from sodium carbonate, potassium carbonate, sodium citrate and sodium malate.

6. An emulsion according to claim 1, wherein an amount of component (a) of component (B) is 0.01 to 10 parts by weight, an amount of component (b) of component (B) is 0.5 to 100 parts by weight and an amount of component (C) is 0.05 to 30 parts by weight per 100 parts by weight of component (A).

7. An emulsion according to claim 2 which comprises 0.01 to 100 parts weight of component (D) per 100 pairs by weight of component (A).

8. An emulsion according to claim 3, which comprises 0.05 to 30 parts by weight of component (E) per 100 parts by weight of component (A).

9. An emulsion according to claim 1, wherein a content of solid substances is 15 to 85% by weight.

10. A processed meat comprising an emulsion for processed meat described in claim 1 which is uniformly distributed in meat.

11. A processed meat according to claim 10, which comprises 5 to 30 parts by weight of the emulsion for processed meat per 100 parts by weight of meat which is uniformly distriblLted in the meat.

12. A processed meat according to claim 10, wherein the emulsion for processed meat is uniformly dispersed into meat in accordance with at least one of a process of injecting the emulsion for processed meat into meat and a process of mechanically loosening meat.
